(19) United States
(12) Patent Application Publication
(10) Pub. No.: US 2026/0208754 A1
(43) Pub. Date: Jul. 23, 2026

(54) VEHICLE RANGE

(71) Applicant: Ford Global Technologies, LLC, Dearborn, MI (US)

(72) Inventors: Andrew B. Brown, Royal Oak, MI (US); Brendan Francis Diamond, Naples, FL (US); Anthony Maraldo, Southgate, MI (US); Thomas Anthony Vassa, Sparks, NV (US); Keith Weston, Canton, MI (US)

(73) Assignee: Ford Global Technologies, LLC, Dearborn, MI (US)

(21) Appl. No.: 19/029,232

(22) Filed: Jan. 17, 2025

(51) Int. Cl. B60W 50/14; B60L 58/13; B60W 10/04; B60W 10/18; B60W 50/00; G01C 21/34; G06V 20/56

(52) U.S. Cl. CPC B60W 50/14; B60L 58/13; B60W 10/04; B60W 10/18; B60W 50/0097; G01C 21/3469; G06V 20/588; B60L 2240/64; B60L 2250/16; B60L 2260/52; B60L 2260/54; B60W 2050/146; B60W 2420/403; B60W 2510/244; B60W 2530/20; B60W 2552/40; B60W 2556/40

(57) ABSTRACT

A change of a classification of a ground surface on which a vehicle is traveling can be detected when the ground surface on which the vehicle is traveling changes to a new ground surface on which the vehicle is traveling from a prior ground surface on which the vehicle was traveling. Based on the change of classification and an amount of stored energy in the vehicle, a vehicle range is predicted for the new ground surface. A vehicle component is actuated based on the range.

### BACKGROUND

Ground vehicles can operate on a variety of ground surfaces, such as asphalt, concrete, dirt, sand, etc. Travel of a vehicle on a ground surface can be affected by various conditions or phenomena, such as an amount of moisture on the ground surface, a humidity level, a temperature, potholes, bumps, etc. Ground vehicles operating on ground surfaces can be powered by electricity and/or a combustible fuel, and accordingly may be equipped with electric motors and/or internal combustion engines.

### BRIEF DESCRIPTION OF THE DRAWINGS

FIG. 1 is a diagram of an example vehicle system.

FIG. 2 is a diagram of an example process for operating a vehicle according to a range determination.

### DESCRIPTION

### Introduction

Described herein are techniques for determining and/or managing vehicle range and/or energy consumption. A vehicle can include a computer that can determine a range prediction for the vehicle, that is, an amount of combustible fuel and/or electricity available for the vehicle to operate before energy must be replenished. The present disclosure provides for enhanced vehicle operation by enhancing range determinations to support vehicle operations. In examples, the vehicle computer can enhance range determinations and vehicle operation according to a ground surface and/or a change of ground surface on which the vehicle is traveling. Predicting the vehicle range based on a change of a classification of the ground surface can enhance vehicle operation by supporting more efficient operation of vehicle propulsion and/or braking, by allowing for better estimates of range to be provided to a vehicle operator and/or a route planning module, including supporting determining a route for the vehicle based on the predicted range.

A vehicle range is a value that describes a distance and/or a time that the vehicle can operate before refueling and/or recharging. A vehicle range can be expressed as a distance that a vehicle can travel until available energy is completely consumed, that is, until the vehicle will have no further stored energy (i.e., combustible fuel and/or electricity) to power movement of the vehicle. Herein, “energy” stored in/or consumed by a vehicle means electricity, a combustible fuel, or a combination of electricity and a combustible fuel. For example, an amount of electricity available for discharge from a vehicle battery could be specified in kilowatt hours. An amount of combustible fuel such as gasoline or diesel fuel available in a vehicle fuel tank could be specified in liters or gallons.

A vehicle range can be determined by a suitable algorithm based on an energy consumption rate. Herein an energy consumption rate means an amount of energy consumed over a distance (e.g., gallons per mile, kilowatt hours per mile) or an energy consumption rate could be expressed as the reciprocal of energy over distance (e.g., miles per gallon, miles per kilowatt hour). Energy consumption rates can be affected by a variety of factors in addition to a current ground surface on which a vehicle is travelling. For example, ambient temperature can affect vehicle energy consumption; in many vehicles cold weather range estimates may generally be lower than warm weather range estimates. Similarly, energy consumption rates can depend on vehicle speeds and/or changes in vehicle speeds. Energy consumption rates at very low and very high speeds may be higher than energy consumption rates at moderate speeds. Further, energy consumption for highway driving with fewer stops and starts or slow-downs and speed-ups is typically different than energy consumption on city streets with frequent stopping and starting or slowing down and speeding up. For example, electric or hybrid powertrain propulsions that recover energy from stopping and starting typically have lower energy consumption rates during city driving, and internal combustion powertrain propulsions typically have lower energy consumption rates during highway driving.

In accord with the present disclosure, a system comprises a processor and a memory, the memory storing instructions executable by the processor, including instructions to: detect a change of a classification of a ground surface from a prior ground surface on which a vehicle was traveling to a new ground surface on which the vehicle is traveling; based on the change of classification and an amount of stored energy in the vehicle, predict a vehicle range for the new ground surface; and actuate a vehicle component based on the range.

A method comprises: detecting a change of a classification of a ground surface from a prior ground surface on which a vehicle was traveling to a new ground surface on which the vehicle is traveling; based on the change of classification and an amount of stored energy in the vehicle, predicting a vehicle range for the new ground surface; and actuating a vehicle component based on the range.

Predicting the vehicle range for the new ground surface can ignore a prior predicted range from when the vehicle was traveling on the prior ground surface. After predicting the vehicle range based on a stored energy consumption rate for the vehicle based on the classification of the new ground surface, thereby obtaining a predicted range for the new ground surface, the predicted range for the new ground surface can then be updated based on measuring energy consumption while the vehicle travels on the new ground surface. Predicting the vehicle range can include obtaining a stored energy consumption rate for the vehicle based on the classification of the new ground surface from an on-board memory or from a remote server.

The vehicle component can be a propulsion or a brake. Actuating the vehicle component can include actuating the computer or a second computer in the vehicle to determine a route for the vehicle based on the range. The vehicle component can be a human-machine interface (HMI) that displays the range for the new ground surface. The HMI can display a second range determined based on the prior ground surface in addition to the range for the new ground surface.

The classification of the ground surface can be based on image data from a vehicle image sensor. The classification of the ground surface can be based on a surface roughness score determined from a plurality of types of vehicle sensors. The classification of the ground surface can be based on a ground friction coefficient determined from vehicle sensor data. The classification of the ground surface can be based on map data. The vehicle range can be predicted based on a tire type deployed on the vehicle in addition to the classification of the ground surface and the amount of stored energy in the vehicle.

### Example System

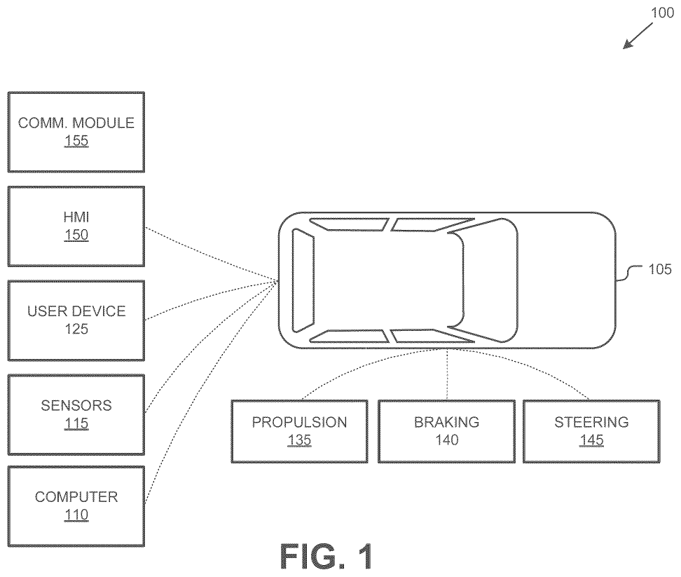

FIG. 1 illustrates an example system 100 for a vehicle 105. A computer 110 in the vehicle 105 is programmed to receive data collected from one or more sensors 115, and other sensors (not shown), to provide certain vehicle data. For example, one or more camera sensors 115 may provide image data from a camera's field of view. A user device with a touch screen may be disposed in vehicle 105. Example user devices include a vehicle computer 110 communicatively coupled (e.g., via a vehicle network) to an HMI 150 with a touch screen installed as part of a vehicle 105 infotainment system, or a hand-held portable computing device 125 with a touch screen. While all modern original equipment manufacturers (OEMs) of passenger vehicles currently warn drivers against using a handheld portable device while driving a vehicle due to safety concerns, it is expected that technology and the regulatory framework may evolve in the future to where such an activity becomes safe and permissible.

Vehicle data may further include a location of the vehicle 105, data about an environment around a vehicle, data about an object outside the vehicle such as another vehicle, etc. A vehicle location may be provided in a conventional form such as by geo-coordinates such as latitude and longitude coordinates obtained via a navigation system that uses a global navigation satellite system (GNSS) such as the Global Positioning System (GPS) system. Further examples of vehicle data can include measurements of vehicle systems and components (e.g., a vehicle speed or velocity, a level of fuel in a fuel tank, an amount of available electric charge, etc.).

A computer 110 can be provided to control one or more vehicle operations including steering, acceleration, speed control, and/or braking. Accordingly, system 100 is shown comprising vehicle 105 which may include Driver Assistance System (DAS) features. A computer 110 (e.g., one or more vehicle 105 electronic control units, i.e., ECUs) can be configured to operate the vehicle 105 independently of operation by an occupant with regard to certain features. A computer 110 may be programmed to provide a driver assistance system (DAS) such as cruise control (where the computer maintains vehicle speed according to a set speed), adaptive cruise control (ACC) (where the computer maintains the vehicle speed according to a set speed but can adjust vehicle speed based on detected distances and/or speeds of other vehicles), and/or hands-free driving. For example, the computer 110 could provide hand-free driving in combination with ACC such that the computer 110 controls steering, braking and acceleration. In another example, the computer 110 could provide ACC and require hands-on operation. The computer 110 may be programmed to operate a powertrain propulsion system 135, a braking system 140, a steering system 145, a device screen that displays a Human Machine Interface (HMI) 150, and/or other vehicle systems.

A computer 110 is generally programmed for communications on a vehicle network (not shown), for example, a conventional vehicle communications bus such as a Controller Area Network (CAN) bus, a Local Interconnect Network (LIN) bus, etc., and/or other wired and/or wireless technologies such as Bluetooth®, Wi-Fi®, Ethernet, etc. via the network, bus, and/or other wired or wireless mechanisms (e.g., a wired or wireless local area network in the vehicle 105), the computer 110 may transmit messages to various devices in the vehicle 105 and/or receive messages from the various devices such as sensors 115, controllers and actuators (not shown), etc.

Alternatively or additionally, for example, in cases where the computer 110 actually comprises multiple devices, the vehicle network may be used for communications between devices represented as the computer 110 in this disclosure. For example, the computer 110 can be a generic computer with a processor and memory as described above, and/or may include a dedicated electronic circuit including an application specific integrated circuit (ASIC) that is manufactured for a particular operation such as an ASIC for processing sensor data and/or communicating the sensor data. In another example, the computer 110 may include a Field-Programmable Gate Array (FPGA), which is an integrated circuit manufactured to be configurable by a user. Typically, a hardware description language such as Very high speed integrated circuit Hardware Description Language (VHDL) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g. stored in a memory electrically connected to the FPGA circuit). In some examples, a combination of processor(s), ASIC(s), and/or FPGA circuits may be included in computer 110.

In addition, the computer 110 may be programmed for communicating with a network and/or devices outside of the vehicle (not shown), which may include various wired and/or wireless networking technologies such as cellular, Bluetooth®, Bluetooth® Low Energy (BLE), wired and/or wireless packet networks, etc.

The memory can be of any type, for example hard disk drives, solid state drives, servers, or any volatile or non-volatile media. The memory can store the collected data sent from the sensors 115. The memory can be a separate device from the computer 110, and the computer 110 can retrieve data stored in the memory via a network in the vehicle 105, for example over a CAN bus, a wireless network, etc. Alternatively or additionally, the memory can be part of the computer 110 (e.g., as a memory of the computer 110).

Sensors 115 can include a variety of devices. For example, various controllers in a vehicle 105 may operate as sensors 115 to provide data via the vehicle network or bus such as data relating to vehicle speed, acceleration, location, subsystem and/or component status, etc. Further, other sensors 115 could include cameras, motion detectors, etc. (i.e., sensors 115 may provide data for evaluating a status of a component, evaluating a slope of a roadway, etc.). The sensors 115 could, without limitation, also include short range radar, long range radar, light detection and ranging (LIDAR), ultrasonic transducers, and the like. Cameras herein typically are optical cameras (e.g., in the visible spectrum, but could alternatively or additionally include other kinds of cameras, e.g., time-of-flight, infrared, etc.).

Collected data can include a variety of data collected in a vehicle 105. Examples of collected data are provided above. Data are generally collected using one or more sensors 115, and may additionally include data calculated therefrom in the computer 110. In general, collected data may include any data gathered by the sensors 115 and/or computed from such data.

The vehicle 105 can include a plurality of vehicle components. In this context, a vehicle component may include one or more hardware components adapted to perform a mechanical function or operation—such as moving the vehicle 105, slowing or stopping the vehicle 105, steering the vehicle 105, etc. Non-limiting examples of components include a powertrain propulsion component 135 (that includes, e.g., an internal combustion engine and/or electric motor, etc.), a transmission component, a steering assembly (e.g., that may include one or more of a steering wheel, a steering rack, etc.), a brake component 140, a park assist component, an adaptive cruise control component, an adaptive steering component 145, a movable seat, and the like. Components can include computing devices such as electronic control units (ECUs) or the like and/or computing devices such as described above with respect to the computer 110, and that likewise communicate via a vehicle network.

The HMI 150 typically includes one or more of a display, a touchscreen display, a microphone, a speaker, etc. The user can provide input to devices such as the computer 110 via the HMI 150. The HMI 150 can communicate with the computer 110 via the vehicle network; for example, the HMI 150 can send a message including the user input provided via a touchscreen, microphone, a camera that captures a gesture, etc., to a computer 110, and/or can display output such as via a screen, speaker, etc.

In addition, the vehicle computer 110 may be configured for communicating via a vehicle-to-vehicle communication module 155 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer (typically via direct radio frequency communications)). The communications module 155 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 155 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 155 according to any suitable short-range communications mechanism (e.g., DSRC, cellular, or the like).

### Implementation Examples

The vehicle computer 110 memory typically stores instructions to execute a conventional range prediction algorithm that predicts a vehicle range based on an amount of available energy and a rate of energy consumption. In such an algorithm, the rate of energy consumption may be determined by taking an average and/or some other statistical measure of energy consumption for a recent period of time or a recent distance traveled.

The vehicle computer 110 further includes instructions to detect that a vehicle 105 is traveling on a new ground surface, that is, has transitioned from a first (i.e., prior) ground surface to a second (i.e., new) ground surface. Put another way, the computer 110 could detect that a current ground surface on which the vehicle 110 is travelling is a new ground surface. Typically, this means that the computer 110 stores executable instructions to determine a classification of the ground surface on which the vehicle 105 is traveling and to detect that the classification of a ground surface on which a vehicle 105 is traveling has changed from a prior classification of prior ground surface on which the vehicle 105 was traveling. The classification identifies a type of ground surface and, as explained below, could be specified in a variety of ways. Upon (i.e., in response to or based on) detecting that the ground surface classification has changed, the computer 110 can predict a vehicle range based on the new ground surface.

In an example, predicting the vehicle range for the new ground surface includes updating a range determined for the prior ground surface classification. That is, upon detecting the new ground surface (i.e., that the ground surface classification has changed), the computer 110 can apply a weight to the range or to the energy consumption rate that the vehicle computer 110 is using to determine the vehicle range. For example, if a vehicle 105 transitions from a ground surface classified as “pavement” to a new ground surface classified as “sand,” the computer 110 could access a stored weight relating an energy consumption rate for the vehicle 105 on pavement to an energy consumption rate for the vehicle 105 on sand. For the sake of illustration, assume that the computer 110 stores weight data specifying that the energy consumption rate for the vehicle 105 on sand is 50% of the energy consumption rate for the vehicle 105 on pavement. Then when the vehicle 105 transitions from pavement to sand, the vehicle range determined for pavement could be updated by applying a weight of 0.5, and then this updated range could be further updated by any suitable range prediction algorithm being used by the vehicle computer 110 to determine the vehicle range.

Alternatively, the computer 110 could discard or ignore a prior range prediction (i.e., for the old or prior ground surface). The computer 110 could then output a range prediction for the new ground surface based on measuring energy consumption on the new ground surface. As will be understood, the range prediction for the new ground surface may not be meaningful until the vehicle 105 has traveled on the new ground surface for a sufficient time and/or distance to determine a realistic energy consumption rate for the new ground surface. In some examples, the computer 110 can delay output of a predicted range for the vehicle 105 (e.g., to an HMI 150) on a new ground surface until the vehicle had traveled a sufficient distance and/or for a sufficient amount of time to determine the energy consumption rate for the new ground surface. The sufficient distance and/or time could be empirically determined, that is, by operating the vehicle on various ground surfaces and observing outputted range predictions to determine an amount of time and/or distance after which the computer 110 outputs a realistic range prediction.

Ground surface classifications are typically specified based on expecting different ground surface classifications to result in different energy consumption rates by a vehicle 105, other factors (such as vehicle speed, rate of incline, etc.) being equal. The classification of the ground surface may specify a material of the ground surface, such as concrete, asphalt, gravel, dirt, sand, mud, etc. Alternatively or additionally, the classification of the ground surface could specify a navigational or map classification, such as a road, highway, an off-road surface, etc.

The computer 110 may be programmed to determine the classification of the road surface in one or more ways. For example, one or more vehicle image sensors 115 could capture images that the computer 110 could input to a suitable image recognition program to output a ground surface classification. In one example, image sensors 115 are cameras operating in the visible spectrum, but other types of cameras and/or image sensors 115 could additionally or alternatively be utilized, such as a lidar (light detection and ranging) sensor, for example. Yet further alternatively or additionally, the computer 110 could determine the ground surface classification could be determined from stored map data. The vehicle 105 could include a suitable geo-location device or sensor 115 that outputs a location of the vehicle 105 on the surface of the earth, for example according to conventional geo-coordinates specifying a latitude and longitude. The computer 110 could access a memory or storage local to the vehicle 105 and including map data specifying a ground surface classification for various geo-coordinates, whereby the computer 110 could look up a ground surface classification for a current location of the vehicle 105. Yet further alternatively or additionally, the computer 110, via the communication module 155, could obtain a ground surface classification from a remote server (not shown) by providing a current set of geo-coordinates.

Along with the classification of the ground surface, the classification of the ground surface could specify a physical condition of the ground surface, such a temperature, a presence and/or amount of water, a presence amount of ice or snow, etc. Thus, for example, concrete-wet and concrete-dry could be different classifications, dirt-dry and dirt-icy could be different classifications, etc.

In a further example, the ground surface classification is based on, or could be expressed as, a surface roughness score determined from a plurality of types of vehicle sensors. The surface roughness score, which may also be referred to as a rough road index, can be determined in any suitable manner, such as based on inputs from vehicle sensors including wheel speed sensors and accelerometers. In one example, the rough road index is specified on a scale of 1 to 20. A surface roughness score, or a range of surface roughness scores, could then be defined as a ground surface classification. For example, if surface roughness scores ranged from 1 to 20, respective ground surface classifications could range from 1 to 3, 4 to 6, 7 to 9, 10 to 12, 13 to 15, 16 to 18, and 19 to 20. The surface roughness score could be input to a suitable range prediction algorithm to weight or modify an energy consumption rate used to predict range, for example. For example, empirical testing could be done to obtain data such as:
Gross train weight estimations from an aggregate of all surfaces traversed;
Vehicle slip controls data for relative wheel speed of all wheels, including indications of wheel slip;
Vehicle torque command by the driver;
Vehicle acceleration data based on torque demand;
Vehicle regenerative braking data;
Data for brake retarding torque at each wheel and associated vehicle deceleration (vehicles typically decelerate more quickly in deformable malleable surfaces); and/or
Fuel or energy consumption data for how much energy is consumed by the powertrain to maintain road load (which will vary based on the surface) or accelerate the vehicle. A characterization equation roughness_index=f(x) could then be developed from vehicle data, which the inputs to the function f(x) could be any of the above data, for example, as input to a machine learning program trained to output the roughness index based on the various data inputs.

In a yet further example, wherein the classification is based on a ground friction coefficient determined from vehicle sensor data. That is, any suitable technique for determining the ground surface friction coefficient for a current ground surface could be used. As will be appreciated, various may be vehicle sensor data, such as available within the context of a traction control system, could be used. As with the surface roughness score, a friction coefficient or a range of friction coefficients could be defined as a ground surface classification. A friction coefficient could be input to a suitable range prediction algorithm to weight or modify an energy consumption rate used to predict range, for example.

Upon determining the vehicle range based on a ground surface classification and an amount of available energy, the computer 110 could actuate a vehicle component based on the range. For example, the computer 110 could actuate the HMI 150 to output the range (e.g., on a screen visible to a vehicle operator). In some examples, the computer 110 may also output a range determination from the prior ground surface, that is, a range prediction as would be conventionally provided without detecting that the vehicle 105 had transitioned to a new ground surface. Alternatively or additionally, the computer could actuate a propulsion, braking, and or steering components, such as a powertrain propulsion system in a manner to be more efficient for a new ground surface, such as by modifying an acceleration command or powertrain propulsion torque command based on the predicted range, for example, reducing requested acceleration or torque based on a ground surface classification (e.g., sand or mud as opposed to pavement) and a predicted range (e.g., a predicted range falling when a new ground surface has a higher energy consumption rate.

Further alternatively or additionally, a component actuated based on a predicted range based on a new ground surface classification could be the computer 110 or a second computer in the vehicle that executes instructions to determine a route for the vehicle 105 based on the predicted range on the new ground surface. For example, if a predicted range based on a new ground surface is insufficient to travel a distance to a destination on the new ground surface, the computer 110 could be programmed to determine a route utilizing a different ground surface on which the vehicle 105 is likely to have a more efficient energy consumption rate, and a greater predicted range, that will allow it to reach the destination.

In examples herein, a vehicle range for a ground surface ignores a prior predicted range when the vehicle 105 was traveling on a prior ground surface. Range prediction methods are often cumulative; that is, the method may consider available energy and a vehicle's energy average or estimated consumption rate for a prior historical period or distance to predict a possible range until the vehicle's stored energy is consumed. Techniques herein, in contrast, typically ignore or discard historical energy consumption data for a time up to and including a time when a new ground surface is detected. Thus, techniques herein can provide a range estimate more likely to be accurate for a current ground surface by ignoring data relating to a different ground surface.

For example, a prior range prediction could be provided while a vehicle 105 is traveling on asphalt, for example. However, when a vehicle 105 transitions from an asphalt ground surface to some other ground surface, such as dirt or sand, the prior predicted range may now be of limited or no relevance because the powertrain propulsion of the vehicle 105, typically an electric motor and/or internal combustion engine, will operate with a different efficiency, that is, will consume energy at a different rate, on the new current ground surface. Typically, the vehicle 105 powertrain propulsion will be significantly less efficient on a dirt ground surface, especially one that is sandy or muddy, than on asphalt. For example, energy consumption could increase by 200% or more per unit distance when a vehicle 105 transitions from asphalt to dirt or sand.

An energy consumption rate, and/or a weight therefor, for determining a predicted range for a respective ground surface classification can be obtained from prior data for the vehicle 105 and/or from other similar vehicles 105, such as from crowd-sourced data or data obtained by empirical testing by a vehicle manufacturer. The vehicle computer 110 can store energy consumption rates and/or weights for respective ground surface classifications for a vehicle 105. That is, as the vehicle 105 operates on a ground surface of a specified classification, such as asphalt, dirt, etc., the computer at 105 could store the energy consumption rate experienced while operating on the ground surface. The computer 110 could store one energy consumption rate for a ground surface classification, or could additionally store multiple energy consumption rates, for example, energy consumption rates applicable at various respective ambient temperatures, for a ground surface classification. For example, at a time of vehicle 105 manufacture, energy consumption rates for respective ground surface classifications could be stored in a memory accessible by the computer 110. Alternatively or additionally, the vehicle computer 110 could track energy consumption rates over times or distances for various ground surface classifications and then could store such historical energy consumption rates for respective ground surface classifications. Yet further alternatively or additionally, the vehicle computer 110 could update energy consumption rates originally stored in a memory at a time of vehicle manufacture based on such historical data. Yet further alternatively or additionally, the vehicle computer 110 could retrieve energy consumption rates for one or more respective ground surface classifications (e.g., in real time, periodically, etc.) from a remote server via the communication module 155.

Because energy consumption rates are typically influenced by other factors, such as temperature, location, vehicle speed, etc., as mentioned above, the energy consumption rate for a ground surface could further alternatively or additionally be determined according to a weighting for a ground surface classification that is applied to the energy consumption rate when the vehicle 105 is operating on a ground surface having the respective ground surface classification. Accordingly, the vehicle computer 110 could store baseline energy consumption rates for a reference or default ground surface, such as pavement or a generic unspecific ground surface, accounting for conventional factors such as vehicle speed and location, and then could weight the baseline or reference energy consumption rates to obtain energy consumption rates based on other ground surface classifications, that is, multiply the reference energy consumption rate by the weight for the current ground surface classification to obtain the energy consumption rate for the current ground surface classification.

The determined energy consumption rate or a weight for the energy consumption rate for a ground surface classification can be used to obtain the predicted range when the vehicle 105 is on a new ground surface of that classification. That is, once an energy consumption rate is determined for input to a range determination algorithm, then a suitable range determination algorithm can be used to obtain the predicted range for the new ground surface. For example, various range prediction algorithms are presently in use in electric, internal combustion, and hybrid vehicles. Alternatively, as mentioned above, the computer 110 could be programmed to output a predicted range for a new ground surface only after the computer 110 had sufficient data for the new ground surface, that is, only after the vehicle 105 had traveled a sufficient distance and/or time to determine an energy consumption rate for the new ground surface for predicting a range for the new ground surface.

As the vehicle travels on the new ground surface (i.e., having a different classification than a prior ground surface), the predicted vehicle range can be updated based on measuring energy consumption while the vehicle travels on the ground surface to obtain a current predicted range. Again, any suitable range prediction technique that accepts the current determined energy consumption rate as an input can be utilized.

Further, an additional input to an algorithm for predicting the vehicle range could be a tire type deployed on the vehicle in addition to the classification and the amount of stored energy in the vehicle. A vehicle range could be affected by a tire type; for example, tires with more defined treads such as for snow or off road operations could be associated with lower energy consumption rates. Tire types could be classified to further weight and energy consumption rate. For example, a default weight could be 1, that is, standard vehicle tires could be assumed in a range prediction algorithm by default. However, for smoother or rougher tires, for example, the weight could be greater than or less than one. The weight associated with a tire type could be provided by user input.

### Example Process

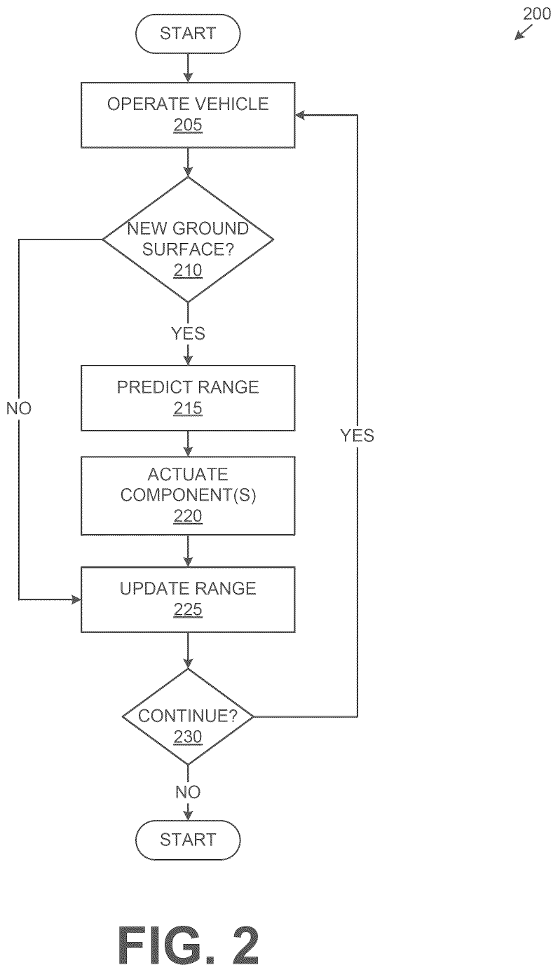

FIG. 2 is a diagram of an example process 200 for operating a vehicle with range predictions based on ground surface classifications. The process 200 may be carried out according to program instructions stored in a memory of, and/or accessible by, a vehicle computer 110 and executed by a processor of the computer 110.

The process 200 begins in a block 205 in which a vehicle 105 is operated on a ground surface. While operating the vehicle 105 on the ground surface, the computer 110 determines and stores a classification of the ground surface and, as represented in the block 210, monitors as described above to determine whether the vehicle 105 has transitioned to a new ground surface, that is, whether a new ground surface classification is determined. If the vehicle has transitioned to a new ground surface, then a block 215 is executed next. Otherwise, the process 200 proceeds to a block 225.

In the block 215, the computer 110 predicts a range for the vehicle 105 based on the new ground surface, that is, based on the classification determined for the new ground surface. As described above, predicting the range for the vehicle 105 is based on an energy consumption rate for the new ground surface, which could be a specified rate of energy consumption for the new ground surface classification and/or a rate of energy consumption determined after the vehicle operated on the new ground surface for a sufficient time and/or distance, possibly combined with other factors such as vehicle speed, ambient temperature, etcetera, or could be a weight applied to a baseline or default rate of energy consumption.

Next, in a block 220, the computer 110 actuates, or provides a message or instructions or commands to one or more other computers in the vehicle 105 to actuate, one or more vehicle components. For example, the current range prediction determined in the block 205 could be output via the HMI 150.

In the block 225, the computer 110 updates the current range prediction. When the block 225 follows the block 220, this means the computer 110 updates an initial range prediction for the new ground surface classification obtained in the block 215. When the block 225 follows the block 210, this means that the computer 110 updates it previously updated range for the ground surface on which the vehicle 105 is being operated as described above regarding the block 205.

Following the block 225, in a block 230, it is determined whether the process 200 continues. For example, the vehicle 105 could be powered off, and operator could provide input to end the process 200, or the process 200 could end for some other suitable reason. If the process 200 is to continue, then the process 200 returns to the block 205. Otherwise, the process 200 ends following the block 230.

### CONCLUDING REMARKS

Systems and methods described herein may be modified and/or omitted depending on the context, situation, and applicable laws, rules, and regulations. Further, regardless of actions that may be taken by a vehicle such as a computer controlling a vehicle, users should use good judgement and common sense when operating the vehicle. Operations described herein should always be implemented and/or performed in accordance with the owner manual and safety guidelines.

The computing devices discussed herein, including computer 110, include processors and memories. The memories generally including instructions executable by one or more of the computing devices'processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions (e.g., from a memory, a computer readable medium, etc.), and executes these instructions, thereby causing one or more actions and/or processes to occur, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in above description of processing, one or more of the steps could be omitted, or the steps could be executed in a different order than shown and described. In other words, the descriptions of systems and/or processes herein are provided for the purpose of illustrating certain embodiments and should in no way be construed so as to limit the disclosed subject matter.

“Based on” means based at least in part on unless explicitly stated otherwise. That is, the phrase “based on” encompasses being partly or entirely based on. Therefore, if A is “based on” B, this means that A could be entirely determined based on B, or could be determined based on B and some other factor or factors.

Accordingly, it is to be understood that the present disclosure, including the above description and the accompanying Figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise.

1. A system, comprising a processor and a memory, the memory storing instructions executable by the processor, including instructions to:
detect a change of a classification of a ground surface from a prior ground surface on which a vehicle was traveling to a new ground surface on which the vehicle is traveling;
based on the change of classification and an amount of stored energy in the vehicle, predict a vehicle range for the new ground surface; and
actuate a vehicle component based on the range.

2. The system of claim 1, wherein predicting the vehicle range for the new ground surface ignores a prior predicted range from when the vehicle was traveling on the prior ground surface.

3. The system of claim 2, the instructions further including instructions to, after predicting the vehicle range based on a stored energy consumption rate for the vehicle based on the classification of the new ground surface, thereby obtaining a predicted range for the new ground surface, then updating the predicted range for the new ground surface based on measuring energy consumption while the vehicle travels on the new ground surface.

4. The system of claim 1, wherein predicting the vehicle range includes obtaining a stored energy consumption rate for the vehicle based on the classification of the new ground surface from an on-board memory or from a remote server.

5. The system of claim 1, wherein the vehicle component is a propulsion or a brake.

6. The system of claim 1, wherein actuating the vehicle component includes actuating the computer or a second computer in the vehicle to determine a route for the vehicle based on the range.

7. The system of claim 1, wherein the vehicle component is a human-machine interface (HMI) that displays the range for the new ground surface.

8. The system of claim 7, wherein the HMI displays a second range determined based on the prior ground surface in addition to the range for the new ground surface.

9. The system of claim 1, wherein the classification of the ground surface is based on image data from a vehicle image sensor.

10. The system of claim 1, wherein the classification of the ground surface is based on a surface roughness score determined from a plurality of types of vehicle sensors.

11. The system of claim 1, wherein the classification of the ground surface is based on a ground friction coefficient determined from vehicle sensor data.

12. The system of claim 1, wherein the classification of the ground surface is based on map data.

13. The system of claim 1, the instructions further including instructions to predict the vehicle range based on a tire type deployed on the vehicle in addition to the classification of the ground surface and the amount of stored energy in the vehicle.

14. A method, comprising:
detecting a change of a classification of a ground surface from a prior ground surface on which a vehicle was traveling to a new ground surface on which the vehicle is traveling;
based on the change of classification and an amount of stored energy in the vehicle, predicting a vehicle range for the new ground surface; and
actuating a vehicle component based on the range.

15. The method of claim 14, wherein predicting the vehicle range for the new ground surface ignores a prior predicted range from when the vehicle was traveling on the prior ground surface.

16. The method of claim 15, further comprising, after predicting the vehicle range based on a stored energy consumption rate for the vehicle based on the classification of the new ground surface, thereby obtaining a predicted range for the new ground surface, then updating the predicted range for the new ground surface based on measuring energy consumption while the vehicle travels on the new ground surface.

17. The method of claim 14, wherein the vehicle component is a propulsion or a brake.

18. The method of claim 14, wherein actuating the vehicle component includes actuating the computer or a second computer in the vehicle to determine a route for the vehicle based on the range.

19. The method of claim 14, wherein the vehicle component is a human-machine interface (HMI) that displays the range for the new ground surface.

20. The method of claim 14, wherein the classification of the ground surface is based on image data from a vehicle image sensor, a surface roughness score determined from a plurality of types of vehicle sensors, a ground friction coefficient determined from vehicle sensor data, map data, and/or a tire type deployed on the vehicle.
